(19) United States
(12) Patent Application Publication
(10) Pub. No.: US 2025/0308109 A1
(43) Pub. Date: Oct. 2, 2025

(54) EDITING DIGITAL IMAGES WITH LOCAL REFINEMENT VIA SELECTIVE FEATURE TRIMMING

(71) Applicant: Adobe Inc., San Jose, UT (US)

(72) Inventors: Yotam Nitzan, Tel-Aviv (IL); Zongze Wu, San Francisco, CA (US); Taesung Park, Albany, CA (US); Richard Zhang, San Francisco, CA (US); Michael Gharbi, San Francisco, CA (US); Elya Shechtman, Seattle, WA (US)

(21) Appl. No.: 18/617,032

(22) Filed: Mar. 26, 2024

(51) Int. Cl. G06T 11/60; G06T 5/60

(52) U.S. Cl. CPC G06T 11/60; G06T 5/60; G06T 2207/20084

(57) ABSTRACT

Methods, systems, and non-transitory computer readable storage media are disclosed for modifying digital images via a generative neural network with local refinement. The disclosed system generates, utilizing an encoder neural network, a latent feature vector of a digital image by encoding global context information of the digital image into the latent feature vector. The disclosed system also determines a modified latent feature vector by trimming the latent feature vector to a feature subset corresponding to a masked portion of the digital image. Additionally, the disclosed system generates, utilizing a generative decoder neural network on the modified latent feature vector, digital image data corresponding to the masked portion of the digital image. The disclosed system also generates a modified digital image including the digital image data corresponding to the masked portion combined with additional portions of the digital image.

### BACKGROUND

Improvements to machine-learning and neural network based image processing technologies have led to significant advancements in the ability of computing systems to generate synthetic digital image content. Specifically, many entities utilize generative neural networks to generate synthetic digital images for use in a number of different applications. For example, entities use generative neural networks for creating new images, replacing objects, inpainting images, or otherwise inserting synthetic digital content into digital images. Although the quality of generative neural networks (e.g., diffusion-based models) has improved rapidly, such neural networks require a significant amount of computing resources. Accordingly, generating digital image content at higher resolutions and/or in iterative image editing processes often results in long, repeated processing times that interrupt the editing/generation processes.

### SUMMARY

One or more embodiments provide benefits and/or solve one or more of the foregoing or other problems in the art with systems, methods, and non-transitory computer readable storage media for editing digital images using a generative neural network with local refinement. The disclosed systems utilize an encoder neural network to generate a latent feature vector that encodes global context information from the digital image as a whole into individual tokens determined from the latent feature vector. For example, the disclosed systems utilize a transformer-based encoder neural network to generate tokens representing patches of the digital image. The disclosed systems determine a modified latent feature vector by trimming the latent feature vector to tokens that represent a feature subset corresponding to a masked portion of the digital image while incorporating global context information in the feature subset. The disclosed systems also generate a modified digital image by utilizing a generative decoder neural network to generate digital image data from the feature subset corresponding to the masked portion of the digital image and blending the digital image data into the rest of the digital image (i.e., at a location of the masked portion). The disclosed systems thus generate an efficient generative encoder-decoder neural network that selectively generates digital image content for only portions of digital images.

### BRIEF DESCRIPTION OF THE DRAWINGS

Various embodiments will be described and explained with additional specificity and detail through the use of the accompanying drawings.

FIG. 1 illustrates an example system environment in which a local refinement generative system operates in accordance with one or more implementations.

FIG. 2 illustrates a diagram of an overview of the local refinement generative system utilizing a generative neural network to modify a masked portion of a digital image via local refinement in accordance with one or more implementations.

FIG. 3 illustrates a diagram of the local refinement generative system encoding global contextual information of a digital image into tokens in accordance with one or more implementations.

FIG. 4 illustrates a diagram of the local refinement generative system generating a modified digital image by selectively modifying a masked portion of a digital image utilizing a generative neural network in accordance with one or more implementations.

FIG. 5 illustrates a diagram of the local refinement generative system combining a generated portion of a digital image with the remaining portion of the digital image in accordance with one or more implementations.

FIG. 6 illustrates a diagram of the local refinement generative system selecting a subset of tokens of an encoded digital image for generating digital image data in accordance with one or more implementations.

FIG. 7 illustrates a diagram of an architecture of a transformer-based encoder-decoder neural network for locally refining a portion of a digital image in accordance with one or more implementations.

FIG. 8 illustrates a graph indicating processing runtimes of the local refinement generative system and an existing system in accordance with one or more implementations.

FIG. 9 illustrates a diagram of an example of the local refinement generative system in accordance with one or more implementations.

FIG. 10 illustrates a flowchart of a series of acts for generating a modified digital image by refining a portion of a digital image utilizing a generative neural network via selective feature trimming in accordance with one or more implementations.

FIG. 11 illustrates a block diagram of an exemplary computing device in accordance with one or more implementations.

### DETAILED DESCRIPTION

One or more embodiments of the present disclosure include a local refinement generative system that edits digital images with a generative neural network via local refinement of features corresponding to specific portions of the digital images. For example, the local refinement generative system determines a digital image to edit by utilizing a generative neural network to generate digital image content for a portion of the digital image according to an image mask. The local refinement generative system encodes global context information from a digital image into a latent feature vector. Additionally, the local refinement generative system trims/modifies the latent feature vector to one or more feature subsets (e.g., sets of tokens) of the latent feature vector corresponding to one or more portions of the digital image based on the image mask. The local refinement generative system also generates digital image data corresponding to the masked portion(s) based on the modified latent feature vector and blends the generated digital image data into the rest of the digital image. Accordingly, the local refinement generative system selectively refines localized portions of digital images by processing feature subsets of the digital images utilizing a generative decoder neural network.

As mentioned, in one or more embodiments, the local refinement generative system generates encodes global context information from a digital image into a latent feature vector. For example, the local refinement generative system utilizes an encoder neural network to encode the global context information of the digital image into individual feature subsets of the latent feature vector. In one or more embodiments, the local refinement generative system utilizes a transformer-based encoder neural network to generate a plurality of tokens representing patches of the digital image and incorporating the global context information into the individual tokens.

Additionally, the local refinement generative system determines a modified latent feature vector by trimming the latent feature vector to a feature subset corresponding to a masked portion of the digital image. In particular, the local refinement generative system determines a subset of tokens of the latent feature vector that correspond to the masked portion of the digital image and trims the latent feature vector to the subset of tokens. In some embodiments, the local refinement generative system includes additional tokens outside a boundary of the masked portion in the subset of tokens to provide additional context or conditioning for a generative neural network.

Furthermore, the local refinement generative system utilizes a generative decoder neural network to generate digital image data from the modified latent feature vector. Specifically, the local refinement generative system provides only the feature subset corresponding to the masked portion to the generative decoder neural network. Accordingly, the generative decoder neural network processes only a portion of the digital image to generate the digital image data. In some embodiments, the generative decoder neural network includes a transformer-based generative decoder neural network that generates digital image data from a subset of tokens corresponding to patches in the masked portion of the digital image. In response to generating the digital image data for the masked portion, the local refinement generative system blends the digital image data back into the rest of the digital image (e.g., in a latent image space).

Some conventional systems that provide synthetic image generation utilize generative neural networks to generate digital images. For example, some conventional systems utilize diffusion-based models to generate high quality digital images based on text or other prompts via iterative decoding layers that incrementally generate digital image content based on a noise input. Although diffusion-based models are increasingly able to produce accurate synthetic image content, conventional systems that leverage the diffusion-based models generate an entire digital image at once. Because the existing approaches generate an entire digital image at once via the diffusion-based models, the conventional systems are inefficient and wasteful by using a significant amount of computing resources.

Furthermore, some conventional systems provide tools for editing a small portion of a digital image (e.g., in image inpainting tasks). Because the conventional systems still generate whole images via the diffusion-based models and perform image blending between an original image and the generated image in a back-end process, the conventional systems are resource expensive and slow. Accordingly, iterative image editing processes that make several small or incremental changes to a digital image using generative neural networks result in significant resource usage to repeatedly generate whole images and blending the small/incremental changes into the digital image. Thus, the conventional systems have consistently high computer resource usage even for small or incremental changes to a digital image due.

The local refinement generative system provides a number of advantages in computing systems that provide digital image generation and editing via generative neural networks. For example, the local refinement generative system improves accuracy by utilizing local refinement of a digital image in a generative neural network via feature trimming. In contrast to conventional systems that generate whole images via diffusion-based models in image generation/editing tasks, the local refinement generative system selectively processes encoded portions of a digital image that correspond to a masked portion of the digital image via a generative decoder neural network. In particular, by trimming a latent feature vector representing a digital image to relevant portions corresponding to an image mask, the local refinement generative system processes only a portion of the digital image through a generative decoder neural network. Thus, the local refinement generative system provides improved processing efficiency and speed when editing digital images because the generative neural network does not generate the whole image every time any change is made to the digital image (e.g., in an inpainting process).

Additionally, the local refinement generative system provides high accuracy in a computing system that generates/edits digital images in addition to providing speed and efficiency. In particular, the local refinement generative system provides comparable accuracy to existing systems by encoding global context information into each of the feature subsets of a latent feature vector representing a digital image. By processing such feature subsets that incorporate global context information utilizing a generative neural network, the local refinement generative system efficiently generates synthetic digital content that also accurately integrates with the rest of the digital image according to the global context information. Accordingly, the local refinement generative system 102 provides minor or iterative local refinement of one or more portions of a digital image that contextually blends generated content into the rest of the digital image.

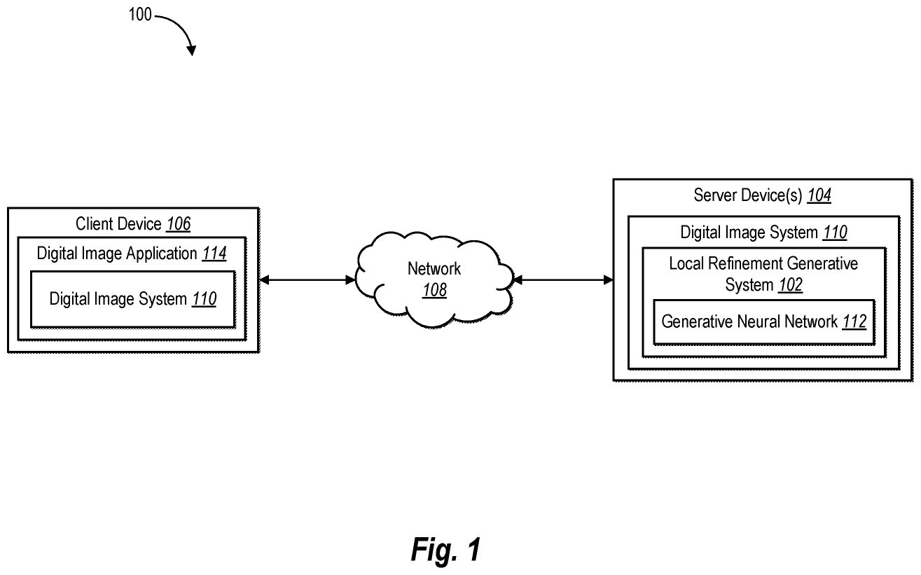

Turning now to the figures, FIG. 1 includes an embodiment of a system environment 100 in which a local refinement generative system 102 is implemented. In particular, the system environment 100 includes server device(s) 104 and a client device 106 in communication via a network 108. Moreover, as shown, the server device(s) 104 include a digital image system 110, which includes the local refinement generative system 102. Additionally, the local refinement generative system 102 includes, or accesses, a generative neural network 112. Although FIG. 1 illustrates that the server device(s) 104 host the generative neural network 112, in alternative embodiments, the generative neural network 112 is hosted by another device or system (e.g., a third-party computing system). Furthermore, the client device 106 includes a digital image application 114, which optionally includes the digital image system 110 (and the local refinement generative system 102).

As shown in FIG. 1, the client device 106 or the server device(s) 104 include or host the digital image system 110. The digital image system 110 includes, or is part of, one or more systems that implement digital image generation or editing operations. For example, the digital image system 110 provides tools for generating or editing digital images (e.g., in image inpainting tasks or other synthetic image content tasks). To illustrate, the digital image system 110 communicates with the client device 106 via the network 108 to provide the tools for display and interaction via the digital image application 114 at the client device 106. Additionally, in some embodiments, the digital image system 110 receives requests to access digital image data stored (e.g., at the server device(s) 104 or at another device such as a database) and/or requests to store digital image data. In some embodiments, the digital image system 110 receives interaction data for viewing or performing various image processing operations and provides the results of the interaction data (e.g., edited digital image data) for display via the digital image application 114 or to a third-party system.

According to one or more embodiments, the digital image system 110 utilizes the local refinement generative system 102 to edit or generate synthetic image data utilizing the generative neural network 112 with local refinement. In particular, the digital image system 110 utilizes the local refinement generative system 102 to encode global context information from a digital image into individual portions of an image encoding for use in selectively refining portions of the digital image. For example, as illustrated in more detail below, the local refinement generative system 102 utilizes the generative neural network 112 to generate digital image data for only a portion of the digital image by trimming a latent feature vector to a feature subset corresponding to the portion of the digital image and blend the digital image data back into the digital image. Accordingly, the local refinement generative system 102 provides selective refinement of localized portions of a digital image via a generative neural network (e.g., a diffusion-based model). Additionally, the local refinement generative system 102 provides tools (e.g., via the digital image application 114) for incremental and iterative digital image editing processes. In some implementations, the local refinement generative system 102 provides tools for generating an utilizing image masks to locally refine portions of digital images.

As illustrated in FIG. 1, the local refinement generative system 102 is implemented on the client device 106 or on the server device(s) 104. In particular, in some implementations, the local refinement generative system 102 on the server device(s) 104 supports the local refinement generative system 102 on the client device 106. For instance, the server device(s) 104 generates or obtains the local refinement generative system 102 (e.g., the generative neural network 112) for the client device 106 (e.g., as part of a software application or suite). The server device(s) 104 provides the local refinement generative system 102 to the client device 106 for performing digital image editing processes at the client device 106. In other words, the client device 106 obtains (e.g., downloads) the local refinement generative system 102 from the server device(s) 104. At this point, the client device 106 is able to utilize the local refinement generative system 102 to edit digital images independently from the server device(s) 104.

In additional embodiments, although FIG. 1 illustrates the server device(s) 104 and the client device 106 communicating via the network 108, the various components of the system environment 100 communicate and/or interact via other methods (e.g., the server device(s) 104 and the client device 106 communicate directly). Furthermore, although FIG. 1 illustrates the local refinement generative system 102 being implemented by a particular component and/or device within the system environment 100, the local refinement generative system 102 is implemented, in whole or in part, by other computing devices and/or components in the system environment 100. For example, in some embodiments, the server device(s) 104 include or host the digital image system 110 and/or the local refinement generative system 102.

To illustrate, the local refinement generative system 102 includes a web hosting application that allows the client device 106 to interact with content and services hosted on the server device(s) 104 (e.g., in a software as a service implementation). To illustrate, in one or more implementations, the client device 106 accesses a web page supported by the server device(s) 104. The client device 106 provides input to the server device(s) 104 to perform image editing operations and, in response, the local refinement generative system 102 or the digital image system 110 on the server device(s) 104 performs operations to edit a digital image via the generative neural network 112. The server device(s) 104 provide the output or results of the operations to the client device 106.

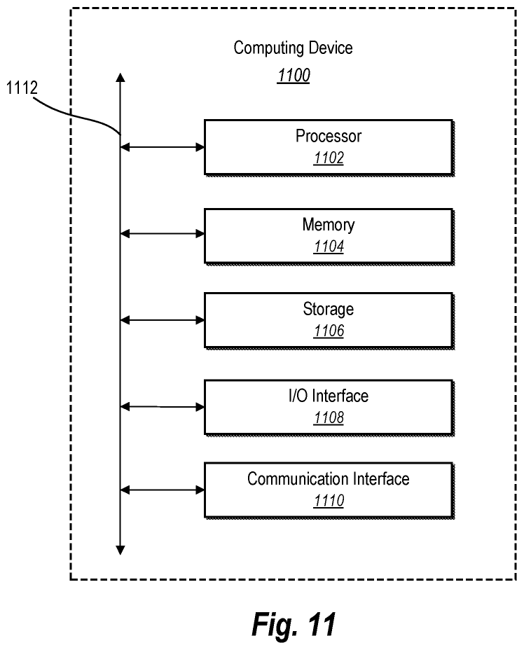

In one or more embodiments, the server device(s) 104 include a variety of computing devices, including those described below with reference to FIG. 11. For example, the server device(s) 104 includes one or more servers for storing and processing data associated with image generation and editing. In some embodiments, the server device(s) 104 also include a plurality of computing devices in communication with each other, such as in a distributed storage environment. In some embodiments, the server device(s) 104 include a content server. The server device(s) 104 also optionally includes an application server, a communication server, a web-hosting server, a social networking server, a digital content campaign server, or a digital communication management server.

In addition, as shown in FIG. 1, the system environment 100 includes the client device 106. In one or more embodiments, the client device 106 includes, but is not limited to, a mobile device (e.g., smartphone or tablet), a laptop, a desktop, including those explained below with reference to FIG. 11). Furthermore, although not shown in FIG. 1, the client device 106 is operable by a user (e.g., a user included in, or associated with, the system environment 100) to perform a variety of functions. In particular, the client device 106 performs functions such as, but not limited to, accessing, viewing, generating, and editing digital images. In some embodiments, the client device 106 also performs functions for generating, capturing, or accessing data to provide to the digital image system 110 and the local refinement generative system 102 in connection with editing digital images. For example, the client device 106 communicates with the server device(s) 104 via the network 108 to provide information (e.g., user interactions) associated with digital images. Although FIG. 1 illustrates the system environment 100 with a single client device, in some embodiments, the system environment 100 includes a different number of client devices.

Additionally, as shown in FIG. 1, the system environment 100 includes the network 108. The network 108 enables communication between components of the system environment 100. In one or more embodiments, the network 108 may include the Internet or World Wide Web. Additionally, the network 108 optionally include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 104 and the client device 106 communicates via the network using one or more communication platforms and technologies suitable for transporting data and/or communication signals, including any known communication technologies, devices, media, and protocols supportive of data communications, examples of which are described with reference to FIG. 11.

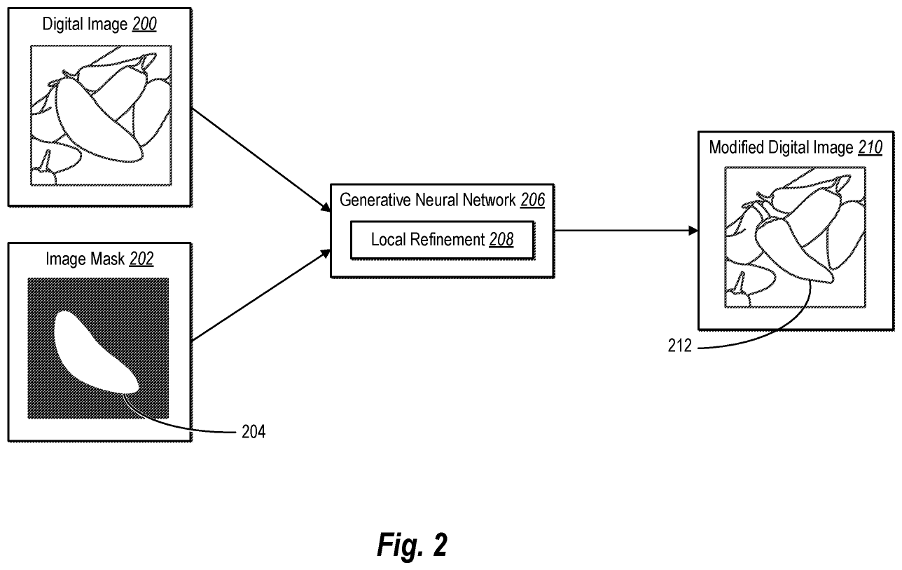

As mentioned, the local refinement generative system 102 utilizes a generative neural network with local refinement to selectively generate synthetic digital image content for editing a digital image. FIG. 2 illustrates the local refinement generative system 102 utilizing a generative neural network to modify a portion of a digital image corresponding to an image mask of the digital image. Specifically, FIG. 2 illustrates that the local refinement generative system 102 utilizes the generative neural network to locally refine the masked portion and blend the refined portion back into the digital image.

As illustrated in FIG. 2, the local refinement generative system 102 determines a digital image 200 to edit. In one or more embodiments, the digital image 200 includes a raster image that the local refinement generative system 102 edits as part of a digital image editing operation. In additional embodiments, the digital image 200 includes a rasterized version of a vector image that the local refinement generative system 102 edits as part of the digital image editing operation. For example, the local refinement generative system 102 determines a request to edit a portion of an existing digital image.

In one or more embodiments, the local refinement generative system 102 determines an image mask 202 that indicates one or more portions of the digital image 200 for editing the digital image 200. For example, the local refinement generative system 102 determines that the image mask 202 includes a masked portion 204 corresponding to a portion of the digital image 200. To illustrate, the masked portion 204 indicates a highlighted portion of the digital image 200 indicated by a user, a portion of the digital image that includes an error (e.g., blurred image content, missing image content, or other artifacts), or a portion of the digital image otherwise selected for editing in one or more image editing processes (e.g., by an object detection model). In some embodiments, the local refinement generative system 102 determines a plurality of image masks corresponding to a plurality of portions of the digital image 200, such as for editing the digital image 200 in a plurality of iterative or incremental editing operations.

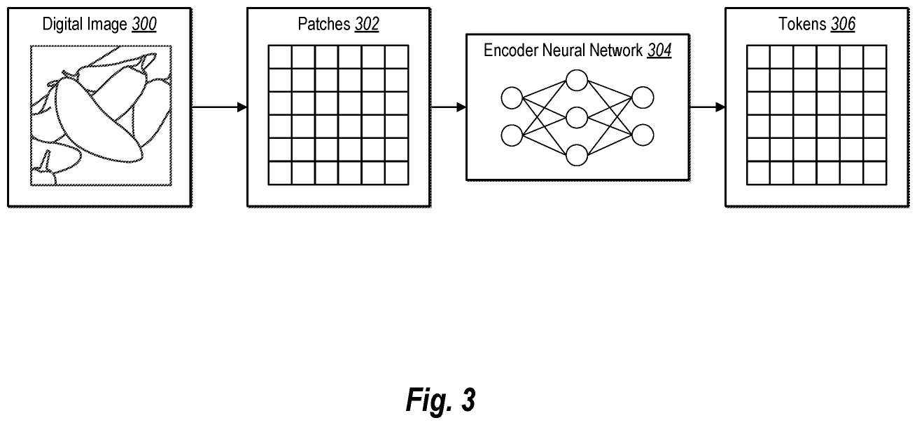

Furthermore, FIG. 2 illustrates that the local refinement generative system 102 that the local refinement generative system 102 utilizes a generative neural network 206 with local refinement 208 to generate digital image data to insert into the digital image 200 at a location based on the image mask 202. In one or more embodiments, digital image data includes synthetic image data generated by the generative neural network 206, such as a set of synthesized (or otherwise modified) tokens. For instance, the local refinement generative system 102 utilizes the generative neural network 206 to generate the digital image data for only the portion of the digital image 200 corresponding to the masked portion 204 by processing a subset of features corresponding to the image portion utilizing the generative neural network 206. Thus, the local refinement generative system 102 utilizes the generative neural network 206 to generate the digital image data, including generating one or more synthetic objects, backgrounds, art, or other image content. FIGS. 3-4, and 6 and the corresponding description provide additional detail related to determining a feature subset for a portion of an image and processing the feature subset utilizing a generative neural network.

Additionally, as illustrated, the generative neural network 206 utilizes local refinement 208 to generate the digital image data for only the portion of the digital image 200 (rather than generating digital image data for the whole image). In one or more embodiments, the generative neural network 206 includes a computer representation that is tuned (e.g., trained) based on inputs to approximate unknown functions. For instance, a neural network includes one or more layers or artificial neurons that approximate unknown functions by analyzing known data at different levels of abstraction. In some embodiments, the generative neural network 206 includes one or more neural network layers including, but not limited to, a convolutional neural network, a recurrent neural network, a transformer-based neural network, or a feedforward neural network that generates data similar to data (e.g., image data) on which the generative neural network 206 is trained.

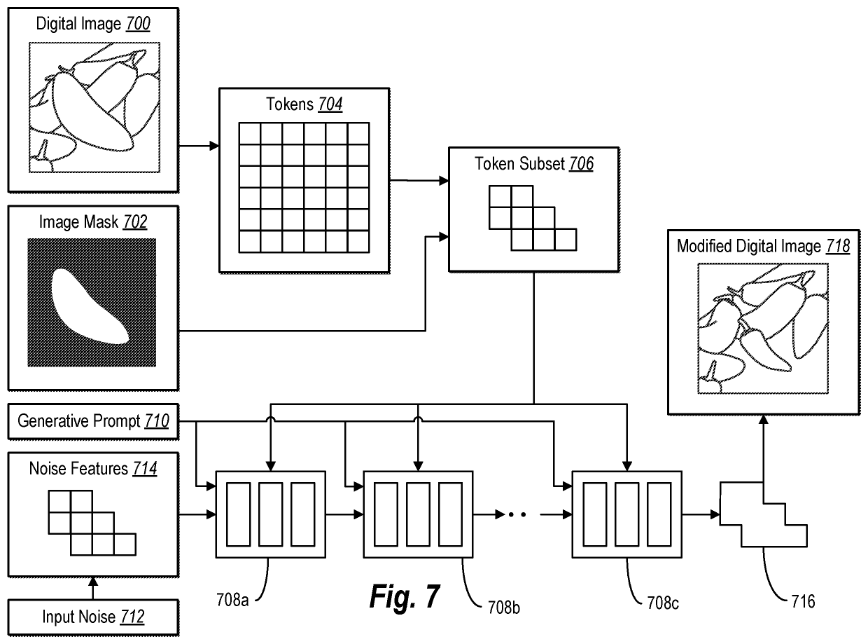

In one or more embodiments, the generative neural network 206 includes, but is not is limited to, a diffusion-based model including one or more transformer-based neural network layers that generate digital image content according to a noise input in a series of diffusion (e.g., denoising) steps. For example, the generative neural network 206 includes a diffusion-based model as described in U.S. application Ser. No. 18/532,457, “SYNTHESIZING SHADOWS IN DIGITALI MAGES UTILIZING DIFFUSION MODELS,” to Kim et al., which is herein incorporated by reference in its entirety. Additionally, in one or more embodiments, the generative neural network 206 includes an encoder neural network that encodes digital images into feature vectors representing image content in a latent image space. FIG. 7 and the corresponding description provide additional detail related to utilizing a generative neural network including a diffusion-based model to locally refine digital image content.

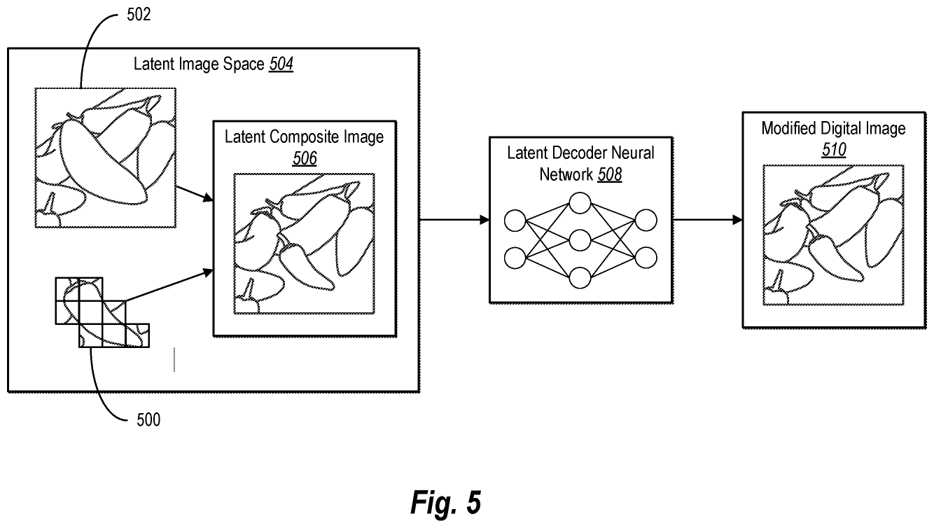

In response to generating digital image data for the portion of the digital image 200 corresponding to the masked portion 204, the local refinement generative system 102 generates a modified digital image 210 including the digital image data (e.g., a generated object 212). Specifically, the local refinement generative system 102 generates the modified digital image 210 by blending the digital image data in the portion of the digital image 200 with the rest of the image content of the digital image 200. Accordingly, the local refinement generative system 102 generates the modified digital image 210 by locally refining the portion of the digital image 200 while ensuring that the digital image data is contextually accurate with the rest of the digital image 200. FIG. 5 and the corresponding description provide additional detail related to combining digital image data generated for a portion of a digital image with the rest of the digital image.

In one or more embodiments, as mentioned, the local refinement generative system 102 includes an encoder neural network that encodes image data from a digital image into a latent image space. FIG. 3 illustrates an example of the local refinement generative system 102 utilizing an encoder neural network to generate a latent feature vector representing digital image content into the latent image space. Specifically, the local refinement generative system 102 utilizes an encoder neural network to encode global context information from the digital image content into individual feature representations for different portions of the digital image content.

In one or more embodiments, as illustrated in FIG. 3, the local refinement generative system 102 utilizes a transformer-based encoder neural network that generates patch encodings representing different portions of a digital image 300. In particular, FIG. 3 illustrates generating encodings for patches 302 of the digital image 300. For example, the local refinement generative system 102 separates the digital image 300 into a plurality of patches 302 for encoding by the encoder neural network 304. In one or more embodiments, the local refinement generative system 102 utilizes the encoder neural network 304 to separate the digital image 300 into the patches 302 and generate tokens 306 representing the patches 302. More specifically, the encoder neural network 304 separates the digital image 300 into the patches 302 for generating the tokens 306.

According to one or more embodiments, the local refinement generative system 102 utilizes the encoder neural network 304 to encode the patches 302 of the latent feature vector into the tokens 306 from an intermediate latent image space into an encoding/embedding space. In particular, the latent feature vector includes an abstracted representation of features of the digital image in a latent feature space, and the tokens include tokenized/encoded features from the latent feature vector according to learned parameters of the encoder neural network 304. For example, the local refinement generative system 102 determines the latent feature vector for the digital image and also determines the tokens 306 from the latent feature vector according to positional encoding information for the patches 302. To illustrate, the encoder neural network 304 subdivides the digital image 300 into the patches 302 and generates a separate token corresponding to each patch. Thus, a token determined from the latent feature vector represents the visual features of a particular patch of the digital image 300 according to the learned parameters of the encoder neural network 304.

In one or more embodiments, the encoder neural network 304 encodes global context information of the digital image 300 into the tokens 306. Specifically, global context information includes contextual relationships among all pixels of the digital image 300. For instance, the global context information includes context such as lighting, reflections, color information, or other information that applies generally to all of the pixels of the image and/or indicates relationships among various pixels across the digital image 300. By encoding the global context information into the tokens 306, the local refinement generative system 102 ensures that each of the tokens 306 includes at least some global context information corresponding to the digital image 300 as a whole. Accordingly, a particular token represents both the local visual features of a particular patch of the digital image 300 and global visual features from the entire digital image 300.

According to one or more embodiments, the local refinement generative system 102 generates the latent feature vector (e.g., the tokens 306) for the digital image 300 in a single pass. For example, the local refinement generative system 102 generates the tokens 306 in a single encoding step via the encoder neural network 304. Additionally, as mentioned, FIG. 3 illustrates that the local refinement generative system 102 generates a latent feature vector including the tokens 306 to represent the patches 302 of the digital image 300 utilizing a transformer-based encoder neural network. In other embodiments, the local refinement generative system 102 utilizes an encoder neural network that generates a latent feature vector with other types of separately identifiable features elements for different portions of the digital image 300. More specifically, in some embodiments, a feature element includes a portion of a latent feature vector (e.g., a token) representing a digital image that corresponds to a specifically identifiable portion of the digital image.

In one or more embodiments, the local refinement generative system 102 combines the digital image 300 with an image mask to determine a masked image prior to generating the encodings. For example, the local refinement generative system 102 masks (e.g., obscures, such as by removing or changing pixel values within a masked region) a portion of the digital image 300 based on the image mask and utilizes the encoder neural network 304 to generate the latent feature vector based on the masked image. Accordingly, the resulting tokens 306 include one or more tokens representing the masked portion.

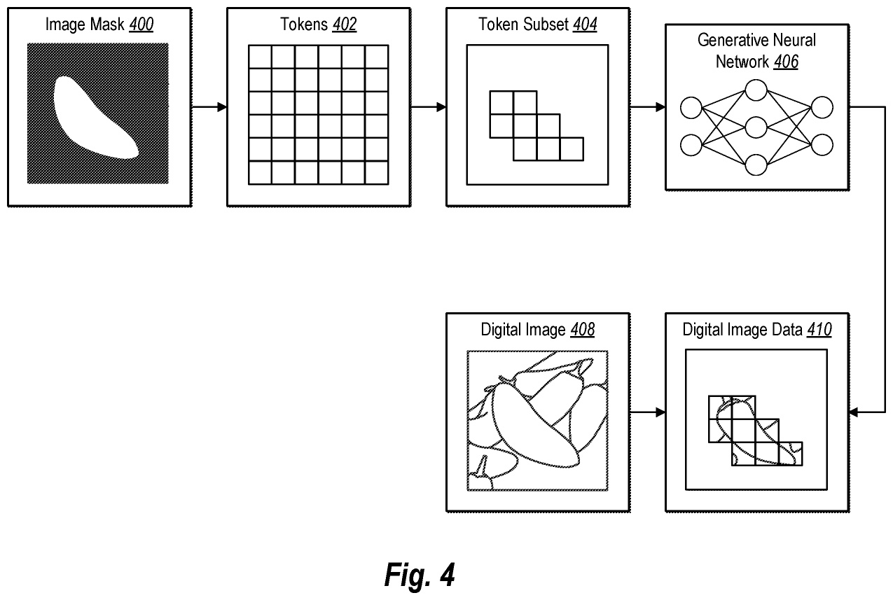

In some embodiments, the local refinement generative system 102 utilizes an image mask for a digital image to determine a specific feature subset (e.g., a portion) of a latent feature vector that corresponds to a specific portion of the digital image. FIG. 4 illustrates an example of the local refinement generative system 102 utilizing an image mask to select a portion of a feature representations (e.g., a latent feature vector) of a digital image for generating new image data via a generative neural network. More specifically, FIG. 4 illustrates that the local refinement generative system 102 selects one or more tokens that represent a masked portion of a digital image and processes the token(s) via the generative neural network, rather than the whole image.

According to one or more embodiments, the local refinement generative system 102 determines an image mask 400 that indicates a specific portion of a digital image 408 to mask. For example, the image mask 400 includes a map of values that indicate which pixels of the digital image 408 to include in the masked portion. To illustrate, the image mask 400 includes binary values (e.g., 0 and 1) corresponding to pixels belonging to at least a first portion of the digital image 408 inside a masked portion and a second portion of the digital image 408 outside the masked portion. Alternatively, the image mask 400 includes an alpha matte with values between 0 and 1 to indicate pixels inside the masked portion, outside the masked portion, and in a blended portion (e.g., including both foreground elements belonging to a masked object and background elements that do not belong to the masked object).

In one or more embodiments, the local refinement generative system 102 generates tokens 402 representing the digital image 408 as described above with respect to FIG. 3. In connection with generating the tokens 402, the local refinement generative system 102 determines a token subset 404 (or other feature subset) from the latent feature vector based on the image mask 400. Specifically, the local refinement generative system 102 determines one or more tokens that correspond to a portion (e.g., one or more patches) of the digital image 408, such as the masked portion indicated by the image mask 400. For example, the local refinement generative system 102 determines the token subset 404 including tokens that correspond to patches located within or including a boundary of the masked portion of the image mask 400.

In at least some embodiments, the local refinement generative system 102 trims the latent feature vector to the token subset 404. In particular, the local refinement generative system 102 determines one or more tokens outside the token subset 404 and removes the corresponding tokens from the latent feature vector. To illustrate, the local refinement generative system 102 removes the corresponding tokens from the latent feature vector, resulting in a smaller latent feature vector. Thus, the local refinement generative system 102 generates a modified latent feature vector that excludes information outside the token subset 404 and is smaller than the initial latent feature vector representing the entire digital image 408. In alternative embodiments, the local refinement generative system 102 zeroes values in the latent feature vector outside the token subset 404.

In response to generating the modified latent feature vector including the token subset 404, the local refinement generative system 102 utilizes a generative neural network 406 to generate image content based on the token subset 404. In one or more embodiments, the local refinement generative system 102 utilizes a generative decoder neural network, such as a diffusion-based model, to process the modified latent feature vector including the token subset 404. More specifically, the local refinement generative system 102 utilizes the generative neural network 406 to generate digital image data 410 corresponding to the masked portion of the digital image 408. For example, the local refinement generative system 102 processes only the token subset 404 (i.e., the modified latent feature vector excluding the trimmed tokens from the latent feature vector of the digital image 408) and generates synthetic digital image content for the digital image 408.

As an example, the local refinement generative system 102 utilizes tokens representing patches of a digital image including a scene including a plurality of objects. The local refinement generative system 102 utilizes an image mask corresponding to a particular object, group of objects, or other content of the digital image to replace the object(s) or content with new content (e.g., based on a text, image, or contextual prompt). The local refinement generative system 102 selects the subset of tokens related to the portion of the digital image and passes the subset of tokens to the generative neural network 406, which generates new content (e.g., the digital image data 410) to insert into the digital image.

As mentioned, in one or more embodiments, the local refinement generative system 102 blends digital image data generated for a portion of a digital image with the rest of the digital image. FIG. 5 illustrates an example of the local refinement generative system 102 blending generated image content into a digital image for locally refining a portion of the digital image. In particular, FIG. 5 illustrates that the local refinement generative system 102 performs a blending operation in a latent image space.

In at least some embodiments, the local refinement generative system 102 generates digital image data 500 for a portion of a digital image 502. In particular, as described above, the local refinement generative system 102 generates the digital image data 500 for a masked portion of the digital image 502 based on a feature subset (e.g., a token subset) representing specific patches of the digital image 502. Additionally, as illustrated, the local refinement generative system 102 converts the digital image data 500 to a latent image space 504. For example, the local refinement generative system 102 generates the digital image data 500 in the same latent image space 504 as the latent feature vector generated by an encoder neural network for the digital image 502. To illustrate, the local refinement generative system 102 maps tokens of the digital image data 500 generated by a generative neural network back into the latent image space 504 with the latent feature vector representing the digital image 502.

In one or more embodiments, the local refinement generative system 102 utilizes the digital image data 500 in the latent image space 504 to determine a partial latent image. For instance, the local refinement generative system 102 generates the partial latent image from the digital image data 500 by determining missing (e.g., trimmed) tokens corresponding to portions of the digital image 502 outside the masked portion. The local refinement generative system 102 generates the partial latent image by assigning uninitialized values (e.g., zeros) to the missing tokens.

In one or more embodiments, the local refinement generative system 102 blends the digital image data 500 with the digital image 502 in the latent image space 504. For example, the local refinement generative system 102 combines the digital image data 500 with the digital image 502 to create a latent composite image 506. Specifically, the local refinement generative system 102 generates the latent composite image 506 by inserting digital image data into a latent feature vector at a position based on the position(s) of the tokens representing the replaced/masked portion. To illustrate, the local refinement generative system 102 combines the digital image data 500 with the latent feature vector of the digital image 502 in the latent image space 504 by combining the partial latent image with the latent feature vector (e.g., via masking) to obtain the latent composite image 506.

As illustrated in FIG. 5, the local refinement generative system 102 utilizes a latent decoder neural network 508 to generate a modified digital image 510 from the latent composite image 506. For example, the local refinement generative system 102 reconstructs the modified digital image 510 from the latent composite image 506 that includes the digital image data 500 generated for a masked portion of the digital image 502 and the original image data outside the masked portion. To illustrate, the local refinement generative system 102 utilizes the latent decoder neural network 508 to convert the latent composite image 506 from the latent image space 504 to the RGB (or other) color space. In additional embodiments, the local refinement generative system 102 further refines the modified digital image 510 by applying one or more additional filters or image processes, such as a blending filter to remove seams resulting from combining the digital image data 500 with the digital image 502 in the latent image space 504.

As mentioned above, the local refinement generative system 102 utilizes a generative neural network to generate synthetic image data to insert into a digital image for local refinement of a portion of the digital image. For example, the local refinement generative system 102 encodes global context information into individual features representing different portions of the digital image. Additionally, the local refinement generative system 102 processes only a portion of the encoded image with a generative neural network to locally refine portions of the digital image according to the global context information. Although the examples above describe processing a subset of tokens corresponding to a masked portions, in additional embodiments, the local refinement generative system 102 also includes additional tokens corresponding to one or more portions outside a masked portion to include additional contextual information in the generated image content.

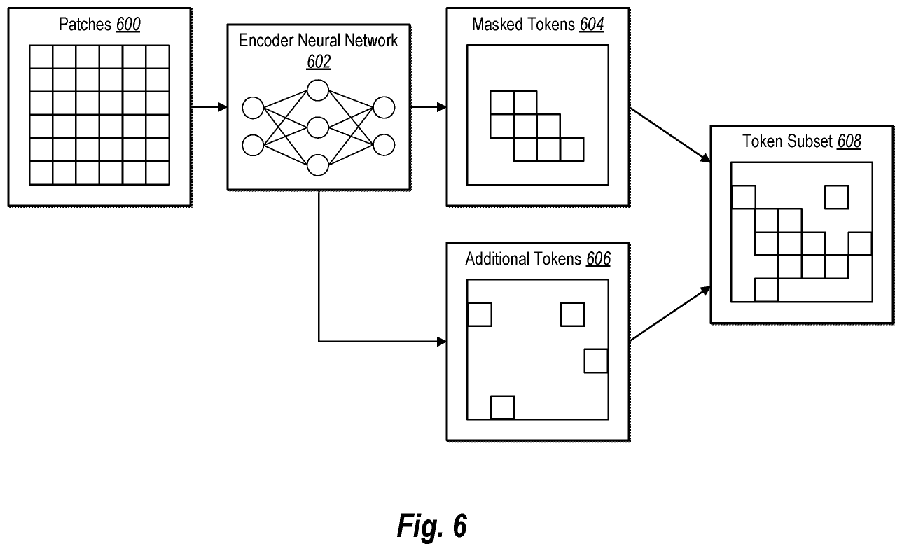

FIG. 6 illustrates an example of the local refinement generative system 102 determining a feature subset including features corresponding to a masked portion of a digital image and various features outside the masked portion. For instance, the local refinement generative system 102 determines processes a digital image to encode patches 600 of the digital image into a latent feature vector. To illustrate, the local refinement generative system 102 utilizes an encoder neural network 602 to generate tokens representing the patches 600 while also encoding global context information into the individual tokens. Additionally, as previously described, the local refinement generative system 102 determines masked tokens 604 including tokens within and/or including a boundary of a masked portion of the digital image.

In some embodiments, in addition to the tokens within or including a boundary of a masked portion of the digital image, the local refinement generative system 102 also determines one or more additional tokens outside the boundary of the masked portion. Specifically, as illustrated in FIG. 6, the local refinement generative system 102 utilizes the encoder neural network 602 to determine additional tokens 606 including additional context information for use in generating digital image data for the masked portion. For example, the encoder neural network 602 includes an additional bank of tokens including various types of context information that the local refinement generative system 102 accesses to select the additional tokens 606.

In one or more embodiments, the local refinement generative system 102 determines the additional tokens 606 in response to determining that the additional tokens 606 include additional contextual information useful in generating synthetic image content for the masked portion. In particular, the additional contextual information includes image data relevant to lighting features, color features, spatial features, or other features. For example, the additional tokens 606 include tokens randomly sampled from portions of the digital image outside a boundary of the masked portion. Alternatively, the additional tokens 606 include tokens corresponding to portions including a variety of visual features (e.g., lighting, color, or spatial as indicated above). In some embodiments, the additional tokens 606 include tokens near (and outside) a boundary of the masked portion. In additional embodiments, the additional tokens 606 include tokens sampled from a variety of different locations of the latent feature vector of the digital image.

As illustrated in FIG. 6, the local refinement generative system 102 determines a token subset 608 based on the masked tokens 604 and the additional tokens 606. For example, the local refinement generative system 102 determines the token subset 608 to include the masked tokens 604 and one or more of the additional tokens 606. To illustrate, the local refinement generative system 102 includes all of the additional tokens 606 with the masked tokens 604 in the token subset 608. Alternatively, the local refinement generative system 102 determines semantic information relevant to the synthetic image content to generate, such as semantic information identified in a prompt to generate the synthetic image content. Accordingly, the local refinement generative system 102 selects one or more additional tokens that include the relevant contextual information. As an example, contextually relevant tokens include similar objects in the digital image, similar lighting, similar color profiles, etc.

FIG. 7 illustrates an embodiment of the local refinement generative system 102 utilizing a generative neural network with local reinforcement in which the generative neural network includes a diffusion model. For example, the local refinement generative system 102 determines a digital image 700 and an image mask 702 indicating a masked portion of the digital image 700. The local refinement generative system 102 generates tokens 704 represents patches of the digital image 700 (and in some embodiments a masked image based on the digital image 700 and the image mask 702). To illustrate, the local refinement generative system 102 utilizes a transformer-based encoder neural network to generate the tokens 704. Furthermore, as illustrates, the local refinement generative system 102 determines a token subset 706 corresponding to a masked portion of the digital image 700 based on the image mask 702.

In one or more embodiments, the local refinement generative system 102 provides the token subset 706 to a transformer-based decoder neural network that includes a diffusion-based model. Specifically, the transformer-based decoder neural network includes a plurality of diffusion decoders that iteratively denoise a noisy input to generate digital image data in a plurality of denoising/sampling steps. For instance, the transformer-based decoder neural network includes a first diffusion decoder 708a, a second diffusion decoder 708b, and an nth diffusion decoder 708c. The transformer-based decoder neural network includes a number of diffusion decoders depending on the quality

Additionally, the local refinement generative system 102 utilizes the diffusion decoders to generate the digital image data based on a generative prompt 710 and a noise input 712. For example, the generative prompt includes a text prompt (e.g., a natural language word or phrase) to generate a specific object, scene, or other image content indicated in the text prompt. Alternatively, the generate prompt includes an image prompt to generate a specific object, scene, or other image content based on digital image content detected in the image prompt.

In some embodiments, the local refinement generative system 102 also determines a set of noise features 714 from the noise input 712. In particular, the noise input 712 includes a randomized noise image including a plurality of noise patches and having dimensions based on the digital image 700. For example, the local refinement generative system 102 determines the noise features 714 corresponding to the token subset 706 (e.g., having a size and a shape based on relative size, shape, and positioning in a latent feature vector of the digital image 700 and an encoding of the noise input 712). Additionally, the local refinement generative system 102 encodes the generative prompt 710.

As illustrated in FIG. 7, the local refinement generative system 102 utilizes the diffusion decoders 708a-708c to iteratively denoise the token subset 706 based on the noise features 714 and the generative prompt 710. The local refinement generative system 102 thus generates digital image data 716 representing only the token subset 706. Additionally, the local refinement generative system 102 blends the digital image data 716 into the digital image 700 to generate a modified digital image 718.

According to a specific implementation of the generative neural network, the local refinement generative system 102 determines an image I∈ [symbol] ^{h×w×3} and a specified region to be edited with a binary mask M∈{0,1}h×w and text prompt c indicating where and what content to generate. Additionally, a mask value of 1 specifies a hole to inpaint, and a mask value of 0 indicates context pixels not to modify. As an example, the image includes a resolution of h=w=1024, though the local refinement generative system 102 also operates accurately on other resolutions.

In one or more embodiments, the local refinement generative system 102 utilizes an encoder neural network that compresses and summarizes the whole image context in a single pass. Additionally, the decoder includes a transformer-based diffusion model that iteratively processes only the masked area to generate digital image content, thereby resulting in lower computation cost and latency than existing systems. Specifically, in some embodiments, the computation cost and latency are proportional to the number of pixels being synthesized.

In one or more embodiments, the local refinement generative system 102 utilizes a generative neural network that operates in an intermediate latent image space with lower resolution (e.g., 8× lower resolution) and a plurality of channels (e.g., c=4) to reduce computation while maintaining visual quality. For example, the local refinement generative system 102 encodes a masked image as a latent feature vector by:

$$Z = ℰ ( I ⊙ ( 1 - M ) ) ∈ ,$$

where ⊙ represents multiplication across the spatial dimensions.

Furthermore, in one or more embodiments, the local refinement generative system 102 utilizes an encoder neural network E that processes the whole image to encode global context information of a visible region into individual encoded tokens such that a downstream decoder synthesizes image data visually consistent with the context. In one or more embodiments, the local refinement generative system 102 divides the latent feature vector Z into N=64×64=4096 patches (e.g., for a 128 size latent dimension, this corresponds to size 4 patches with an overlap of 1 on each side). The local refinement generative system 102 vectorizes the patches, adds positional encodings, passes the encodings to a linear layer, and generates encoded tokens. Accordingly, the encoder neural network transforms the input image into a set of N tokens of dimension d=1152 via [symbol] ₐₗₗ={ [symbol] ₁, [symbol] ₂, . . . , [symbol] _{N}}=E (Z, M), [symbol] ᵢ∈ [symbol] ^{d}. The local refinement generative system 102 processes the mask M utilizing the encoder neural network by a learned downsampling operator to match the spatial dimensions of the latent feature vector.

In one or more embodiments, the local refinement generative system 102 performs a token dropping/trimming operation based on the mask. For example, because the tokens contain global context information (e.g., due to self-attention layers of the encoder neural network enabling all the tokens to interact), the local refinement generative system 102 discards tokens corresponding to a visible region (e.g., outside the masked portion) and keeping the tokens representing the masked portion. By dropping the tokens outside the masked portion, the local refinement generative system 102 forces the encoder E to summarize the input image in a compact set of tokens and ensures the downstream computation scales with the size of the masked portion. Specifically, the decoder neural network only processes tokens corresponding to the masked portion. Additionally, the tokens also represent relevant information for the given location.

In additional embodiments, the local refinement generative system 102 also includes patches with partial holes and blends the visible pixels in those patches in at the output of the generative neural network. The local refinement generative system 102 maxpools the mask M to a 64×64 map and vectorizes the map into a set {mᵢ}ᵢ₌₁⁴⁰⁹⁶, where mᵢ∈{0,1}. Additionally, [symbol] ₕₒₗₑ={ [symbol] ᵢ|mᵢ=1}⊆ [symbol] ₐₗₗ. The remaining Nₕₒₗₑ≤N tokens form the global context.

In at least some embodiments, the local refinement generative system 102 synthesizes the missing pixels (e.g., the masked portion) using a transformer-based diffusion decoder D. Rather than keeping a set N tokens representing the whole image, the local refinement generative system 102 utilizes Nₕₒₗₑ tokens corresponding to the hole, [symbol] ₕₒₗₑ={xᵢ}}. The local refinement generative system 102 utilizes the diffusion decoder to create time-conditioned tokens [symbol] ₕₒₗₑ^{t}={xᵢ^{t}}, where t∈[0, . . . , T], starting at time T with features drawn from a unit Gaussian. Additionally, the local refinement generative system 102 utilizes the decoder to progressively denoise the tokens, conditioned on an encoded text prompt c and the global context produced by the encoder [symbol] ₕₒₗₑ: [symbol] ₕₒₗₑ=D( [symbol] ₕₒₗₑ⊕^{t} [symbol] ₕₒₗₑ; t, c), where ⊕ represents concatenation along the channel dimension of corresponding elements in each set.

In one or more embodiments, the local refinement generative system 102 maps the final tokens [symbol] ₕₒₗₑ⁰ back into the latent image space using a linear layer and the inverse of the patch-splitting operations of the encoder neural network to obtain a partial latent image

$${\hat{Z}}_{hole} = .$$

The local refinement generative system 102 leaves the missing tokens corresponding to the visible pixels uninitialized with zeros. The local refinement generative system 102 combines the partial latent image with the visible latent feature vector using pointwise masking to obtain the final latent composite image: Ź=(1−M)⊙Z+M⊙Źₕₒₗₑ. The local refinement generative system 102 also decodes the final latent composite image via a latent decoder neural network to produce a final RGB image Î= [symbol] (\hat{Z}). Additionally, in some embodiments, the local refinement generative system 102 uses a Poisson blending postprocessing operation in the RGB space to correct any visible seams resulting from blending in the latent image space.

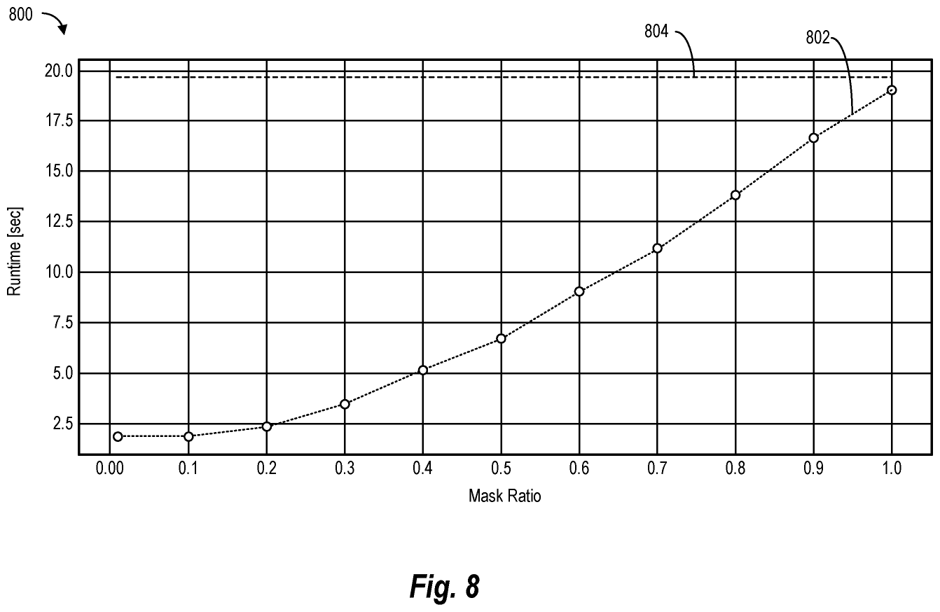

In one experiment performed on a dataset of 1024×1024 resolution images covering a wide variety of objects and scenes with masks and text prompts for editing the images, the local refinement generative system 102 generates modified digital images including synthesized image data. As shown in FIG. 8, the local refinement generative system 102 provides improved processing speeds over existing systems, especially for lower mask ratios. Specifically, as indicated in the graph 800 of FIG. 8, the experiment resulted in a gradually increasing runtime for the local refinement generative system 102 (indicated by a first line 802). Additionally, the experiment resulted in a high, constant runtime for the existing system (indicated by a second line 804) that synthesizes whole images regardless of mask size as described by Junsong Chen, Jincheng Yu, Chongjian Ge, Lewei Yao, Enze Xie, Yue Wu, Zhongdao Wang, James Kwok, Ping Luo, Huchuan Lu, and Zhenguo Li in “PixArt-α: Fast Training of Diffusion Transformer for Photorealistic Text-to-Image Synthesis” in ICLR (2024). Accordingly, the local refinement generative system 102 synthesizes digital image content significantly faster than the existing system while producing comparable quality in the synthesized digital image content.

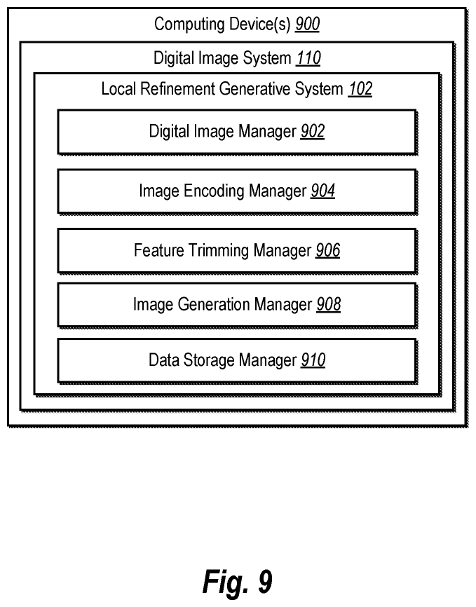

FIG. 9 illustrates a detailed schematic diagram of an embodiment of the local refinement generative system 102 described above. As shown, the local refinement generative system 102 is implemented in a digital image system 110 on computing device(s) 900 (e.g., a client device and/or server device as described in FIG. 1, and as further described below in relation to FIG. 11). Additionally, the local refinement generative system 102 includes, but is not limited to, a digital image manager 902, an image encoding manager 904, a feature trimming manager 906, an image generation manager 908, and a data storage manager 910. In one or more embodiments, the local refinement generative system 102 is implemented on any number of computing devices. For example, the local refinement generative system 102, in one or more embodiments, is implemented in a distributed system of server devices for image generation or editing. Alternatively, the local refinement generative system 102 is also implemented within one or more additional systems. For example, the local refinement generative system 102, in one or more embodiments, is implemented on a single computing device such as a single client device.

In one or more embodiments, each of the components of the local refinement generative system 102 is in communication with other components using any suitable communication technologies. Additionally, the components of the local refinement generative system 102 are capable of being in communication with one or more other devices including other computing devices of a user, server devices (e.g., cloud storage devices), licensing servers, or other devices/systems. It will be recognized that although the components of the local refinement generative system 102 are shown to be separate in FIG. 9, any of the subcomponents may be combined into fewer components, such as into a single component, or divided into more components as may serve a particular implementation. Furthermore, although the components of FIG. 9 are described in connection with the local refinement generative system 102, at least some of the components for performing operations in conjunction with the local refinement generative system 102 described herein may be implemented on other devices within the environment.

In some embodiments, the components of the local refinement generative system 102 include software, hardware, or both. For example, the components of the local refinement generative system 102 include one or more instructions stored on a computer-readable storage medium and executable by processors of one or more computing devices (e.g., the computing device(s) 900). When executed by the one or more processors, the computer-executable instructions of the local refinement generative system 102 cause the computing device(s) 900 to perform the operations described herein. Alternatively, the components of the local refinement generative system 102 include hardware, such as a special purpose processing device to perform a certain function or group of functions. Additionally, or alternatively, the components of the local refinement generative system 102 include a combination of computer-executable instructions and hardware.

Furthermore, the components of the local refinement generative system 102 performing the functions described herein with respect to the local refinement generative system 102 may, for example, be implemented as part of a stand-alone application, as a module of an application, as a plug-in for applications, as a library function or functions that may be called by other applications, and/or as a cloud-computing model. Thus, the components of the local refinement generative system 102 may be implemented as part of a stand-alone application on a personal computing device or a mobile device. Alternatively, or additionally, the components of the local refinement generative system 102 may be implemented in any application that provides digital image difference captioning, including, but not limited to ADOBE® PHOTOSHOP® and ADOBE® CREATIVE CLOUD® software.

As illustrated, the local refinement generative system 102 includes a digital image manager 902 to manage digital images in image editing processes. For example, the digital image manager 902 accesses digital images from a user computing device (e.g., based on a request to upload a digital image) or from a database of images. Additionally, the digital image manager 902 manages image masks associated with the digital images, including generating or otherwise obtaining the image masks.

The local refinement generative system 102 also includes an image encoding manager 904 to encode digital images. For example, the image encoding manager 904 generates a latent feature vector representing a digital image in an intermediate latent image space and a plurality of tokens representing patches of the digital image based on the latent feature vector. Additionally, the image encoding manager 904 encodes global context information into the tokens.

The local refinement generative system 102 further includes a feature trimming manager 906 that modifies feature representations of digital images according to masked or selected portions. For instance, the feature trimming manager 906 generates a modified latent feature vector for a digital image by trimming tokens corresponding to portions outside a masked portion of a digital image. In some embodiments, the feature trimming manager 906 also selects tokens based on additional contextual information.

In one or more embodiments, the local refinement generative system 102 includes an image generation manager 908 to generate digital image data via local refinement. Specifically, the image generation manager 908 utilizes a decoder neural network to process only a subset of tokens corresponding to a masked portion of a digital image and generate synthesize image data for the masked portion. The image generation manager 908 also manages blending synthesized image data back into a digital image.

The local refinement generative system 102 also includes a data storage manager 910 (that comprises a non-transitory computer memory) that stores and maintains data associated with generating synthetic digital images. For example, the data storage manager 910 stores data associated with synthesizing digital image content with local refinement, such as digital images, image masks, latent feature vectors, tokens, and token subsets. In some embodiments, the data storage manager 910 stores synthesized digital image data and modified digital image data. The data storage manager 910 further stores data associated with training and utilizing various neural networks, including an encoder neural network and various decoder neural networks.

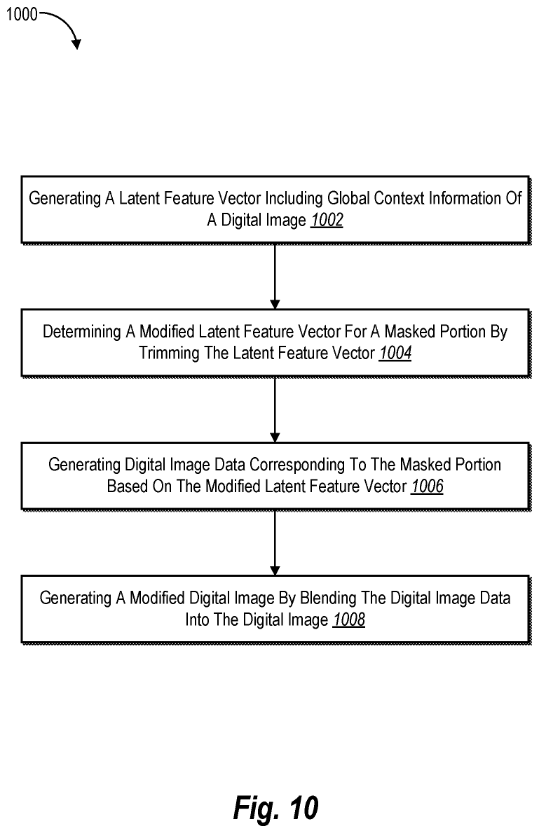

Turning now to FIG. 10, this figure shows a flowchart of a series of acts 1000 of generating a modified digital image by refining a portion of a digital image utilizing a generative neural network via selective feature trimming. While FIG. 10 illustrates acts according to one embodiment, alternative embodiments may omit, add to, reorder, and/or modify any of the acts shown in FIG. 10. The acts of FIG. 10 are part of a method. Alternatively, a non-transitory computer readable medium comprises instructions, that when executed by one or more processors, cause the one or more processors to perform the acts of FIG. 10. In still further embodiments, a system includes a processor or server configured to perform the acts of FIG. 10.

As shown, the series of acts 1000 includes an act 1002 of generating a latent feature vector including global context information of a digital image. The series of acts 1000 also includes an act 1004 of determining a modified latent feature vector for a masked portion by trimming the latent feature vector. The series of acts 1000 further includes an act 1006 of generating digital image data corresponding to the masked portion based on the modified latent feature vector. Additionally, the series of acts 1000 includes an act 1008 of generating a modified digital image by blending the digital image data into the digital image.

In one or more embodiments, act 1002 involves generating, utilizing an encoder neural network, a latent feature vector of a digital image by encoding global context information of the digital image into the latent feature vector. Additionally, act 1004 involves determining a modified latent feature vector by trimming the latent feature vector to a feature subset corresponding to a masked portion of the digital image. Act 1006 involves generating, utilizing a generative decoder neural network on the modified latent feature vector, digital image data corresponding to the masked portion of the digital image. Furthermore, act 1008 involves generating a modified digital image including the digital image data corresponding to the masked portion combined with additional portions of the digital image.

In one or more embodiments, the series of acts 1000 includes generating, utilizing a transformer-based encoder neural network, a latent feature vector corresponding to a plurality of tokens representing patches of a digital image to encode global context information of the digital image into the latent feature vector. The series of acts 1000 also includes determining a modified latent feature vector by trimming the latent feature vector to a feature subset representing a subset of patches of the digital image corresponding to a masked portion of the digital image. Furthermore, the series of acts 1000 includes generating a modified digital image by: generating, utilizing a transformer-based generative decoder neural network on the modified latent feature vector, digital image data for the subset of patches corresponding to the masked portion of the digital image; and combining the digital image data generated for the subset of patches with an additional subset of patches of the digital image outside the masked portion of the digital image.

According to one or more embodiments, the series of acts 1000 includes generating the latent feature vector by utilizing the encoder neural network to extract a plurality of tokens representing patches of the digital image to encode global context information from the digital image into each of the plurality of tokens.

The series of acts 1000 also includes determining the modified latent feature vector comprises: determining a subset of patches of the digital image corresponding to the masked portion of the digital image; and trimming tokens corresponding to the latent feature vector to a subset of tokens representing the subset of patches. For example, the series of acts 1000 includes determining the subset of patches corresponding to the masked portion by determining one or more patches of the digital image including the masked portion of the digital image. Additionally, in some embodiments, the series of acts 1000 includes determining the modified latent feature vector by determining one or more additional patches of the digital image comprising additional contextual information related to the masked portion of the digital image. The series of acts 1000 also includes trimming the latent feature vector by trimming the tokens corresponding to the latent feature vector to a plurality of tokens corresponding to the one or more patches of the digital image including the masked portion and the one or more additional patches of the digital image comprising the additional contextual information related to the masked portion.

In one or more embodiments, the series of acts 1000 includes generating the digital image data corresponding to the masked portion by determining a generative prompt comprising an indication of digital content to insert into the digital image; and generating the digital image data according to the modified latent feature vector and the generative prompt.

The series of acts 1000 further includes determining the modified latent feature vector by: generating noise features representing an input noise comprising a size and a shape corresponding to the masked portion of the digital image; and generating the digital image data utilizing the generative decoder neural network based on the noise features representing the input noise with the modified latent feature vector.

Additionally, the series of acts 1000 includes generating the modified digital image comprises: generating a latent composite image by inserting the digital image data into the digital image in a latent image domain at a location corresponding to the masked portion of the digital image; and generating the modified digital image by utilizing a latent decoder neural network on the latent composite image. The series of acts 1000 further includes generating the digital image data by generating a set of modified tokens representing an object for the masked portion. The series of acts 1000 also includes generating the latent composite image by mapping the set of modified tokens into the latent image domain utilizing a linear neural network layer.

In one or more embodiments, the series of acts 1000 includes determining the modified latent feature vector by: determining an image mask indicating the masked portion of the digital image; and determining, from the image mask, the subset of patches of the digital image corresponding to the masked portion by determining one or more patches within a boundary of the masked portion. In some embodiments, the series of acts 1000 includes determining one or more portions of the digital image comprising additional contextual information related to the masked portion of the digital image, the one or more portions outside a boundary of the masked portion. Additionally, the series of acts 1000 includes determining the subset of patches including one or more additional patches of the one or more portions comprising the additional contextual information related to the masked portion with the one or more patches within the boundary of the masked portion.

Furthermore, in some embodiments, the series of acts 1000 includes accessing a set of global context tokens stored by the transformer-based encoder neural network, the set of global context tokens corresponding to regions outside the masked portion of the digital image. The series of acts 1000 further includes determining, from the set of global context tokens and based on a generative prompt, one or more tokens including the additional contextual information.

In one or more embodiments, the series of acts 1000 includes generating the digital image data by generating, utilizing the transformer-based generative decoder neural network, a set of modified tokens corresponding to the masked portion of the digital image based on the feature subset of the modified latent feature vector with noise features corresponding to the masked portion. In some embodiments, the series of acts 1000 includes combining the digital image data with the additional subset of patches by determining an additional set of tokens corresponding to the additional subset of patches of the digital image from the latent feature vector in a latent image space. For example, the series of acts 1000 includes determining a latent composite image by combining the set of modified tokens with the additional set of tokens in the latent image space; and generating the modified digital image utilizing a latent decoder neural network on the latent composite image.

In some embodiments, the series of acts 1000 includes generating the digital image data by: determining a text prompt indicating an object to generate within the masked portion of the digital image; and determining, utilizing the transformer-based generative decoder neural network, the modified latent feature vector, based on the feature subset representing the subset of patches of the digital image and the text prompt.

The series of acts 1000 also includes generating the latent feature vector by utilizing a transformer-based encoder neural network to extract a plurality of tokens representing patches of the digital image. The series of acts 1000 further includes determining the modified latent feature vector by trimming the latent feature vector to a set of tokens representing patches corresponding to the masked portion of the digital image.

The series of acts 1000 also includes generating the digital image data by generating, utilizing a transformer-based decoder neural network, a modified feature set from the feature subset corresponding to the masked portion of the digital image. For example, generating the modified digital image includes mapping the modified feature set into a latent image domain utilizing a linear neural network layer. Additionally, generating the modified digital image includes generating a latent composite image by combining the modified feature set in the latent image domain with an additional feature set corresponding to a portion of the digital image outside the masked portion. Generating the modified digital image also includes generating, utilizing a latent decoder neural network, the modified digital image from the latent composite image.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates a block diagram of exemplary computing device 1100 that may be configured to perform one or more of the processes described above. One will appreciate that one or more computing devices such as the computing device 1100 may implement the system(s) of FIG. 1. As shown by FIG. 11, the computing device 1100 can comprise a processor 1102, a memory 1104, a storage device 1106, an I/O interface 1108, and a communication interface 1110, which may be communicatively coupled by way of a communication infrastructure 1112. In certain embodiments, the computing device 1100 can include fewer or more components than those shown in FIG. 11. Components of the computing device 1100 shown in FIG. 11 will now be described in additional detail.

In one or more embodiments, the processor 1102 includes hardware for executing instructions, such as those making up a computer program. As an example, and not by way of limitation, to execute instructions for dynamically modifying workflows, the processor 1102 may retrieve (or fetch) the instructions from an internal register, an internal cache, the memory 1104, or the storage device 1106 and decode and execute them. The memory 1104 may be a volatile or non-volatile memory used for storing data, metadata, and programs for execution by the processor(s). The storage device 1106 includes storage, such as a hard disk, flash disk drive, or other digital storage device, for storing data or instructions for performing the methods described herein.

The I/O interface 1108 allows a user to provide input to, receive output from, and otherwise transfer data to and receive data from computing device 1100. The I/O interface 1108 may include a mouse, a keypad or a keyboard, a touch screen, a camera, an optical scanner, network interface, modem, other known I/O devices or a combination of such I/O interfaces. The I/O interface 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 1108 is configured to provide graphical data to a display for presentation to a user. The graphical data may be representative of one or more graphical user interfaces and/or any other graphical content as may serve a particular implementation.

The communication interface 1110 can include hardware, software, or both. In any event, the communication interface 1110 can provide one or more interfaces for communication (such as, for example, packet-based communication) between the computing device 1100 and one or more other computing devices or networks. As an example, and not by way of limitation, the communication interface 1110 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 1110 may facilitate communications with various types of wired or wireless networks. The communication interface 1110 may also facilitate communications using various communication protocols. The communication infrastructure 1112 may also include hardware, software, or both that couples components of the computing device 1100 to each other. For example, the communication interface 1110 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
generating, utilizing an encoder neural network, a latent feature vector of a digital image by encoding global context information of the digital image into the latent feature vector;
determining a modified latent feature vector by trimming the latent feature vector to a feature subset corresponding to a masked portion of the digital image;
generating, utilizing a generative decoder neural network on the modified latent feature vector, digital image data corresponding to the masked portion of the digital image; and
generating a modified digital image including the digital image data corresponding to the masked portion combined with additional portions of the digital image.

2. The computer-implemented method of claim 1, wherein generating the latent feature vector comprises utilizing the encoder neural network to extract a plurality of tokens representing patches of the digital image to encode global context information from the digital image into each of the plurality of tokens.

3. The computer-implemented method of claim 1, wherein determining the modified latent feature vector comprises:
determining a subset of patches of the digital image corresponding to the masked portion of the digital image; and
trimming tokens corresponding to the latent feature vector to a subset of tokens representing the subset of patches.

4. The computer-implemented method of claim 3, wherein determining the subset of patches corresponding to the masked portion comprises determining one or more patches of the digital image including the masked portion of the digital image.

5. The computer-implemented method of claim 4, wherein:
determining the modified latent feature vector comprises determining one or more additional patches of the digital image comprising additional contextual information related to the masked portion of the digital image; and
trimming the latent feature vector comprises trimming the tokens corresponding to the latent feature vector to a plurality of tokens corresponding to the one or more patches of the digital image including the masked portion and the one or more additional patches of the digital image comprising the additional contextual information related to the masked portion.

6. The computer-implemented method of claim 1, wherein generating the digital image data corresponding to the masked portion comprises:
determining a generative prompt comprising an indication of digital content to insert into the digital image; and
generating the digital image data according to the modified latent feature vector and the generative prompt.

7. The computer-implemented method of claim 1, wherein determining the modified latent feature vector comprises:
generating noise features representing an input noise comprising a size and a shape corresponding to the masked portion of the digital image; and
generating the digital image data utilizing the generative decoder neural network based on the noise features representing the input noise with the modified latent feature vector.

8. The computer-implemented method of claim 1, wherein generating the modified digital image comprises:
generating a latent composite image by inserting the digital image data into the digital image in a latent image domain at a location corresponding to the masked portion of the digital image; and
generating the modified digital image by utilizing a latent decoder neural network on the latent composite image.

9. The computer-implemented method of claim 8, wherein:
generating the digital image data comprises generating a set of modified tokens representing an object for the masked portion; and
generating the latent composite image comprises mapping the set of modified tokens into the latent image domain utilizing a linear neural network layer.

10. A system comprising:
one or more memory devices comprising a digital image; and
one or more processors coupled to the one or more memory devices that cause the system to perform operations comprising:
generating, utilizing a transformer-based encoder neural network, a latent feature vector corresponding to a plurality of tokens representing patches of a digital image to encode global context information of the digital image into the latent feature vector;
determining a modified latent feature vector by trimming the latent feature vector to a feature subset representing a subset of patches of the digital image corresponding to a masked portion of the digital image; and
generating a modified digital image by:
generating, utilizing a transformer-based generative decoder neural network on the modified latent feature vector, digital image data for the subset of patches corresponding to the masked portion of the digital image; and
combining the digital image data generated for the subset of patches with an additional subset of patches of the digital image outside the masked portion of the digital image.

11. The system of claim 10, wherein determining the modified latent feature vector comprises:
determining an image mask indicating the masked portion of the digital image; and
determining, from the image mask, the subset of patches of the digital image corresponding to the masked portion by determining one or more patches within a boundary of the masked portion.

12. The system of claim 11, wherein determining the subset of patches comprises:
determining one or more portions of the digital image comprising additional contextual information related to the masked portion of the digital image, the one or more portions outside a boundary of the masked portion; and
determining the subset of patches including one or more additional patches of the one or more portions comprising the additional contextual information related to the masked portion with the one or more patches within the boundary of the masked portion.

13. The system of claim 12, wherein determining the one or more portions of the digital image comprising the additional contextual information comprises:
accessing a set of global context tokens stored by the transformer-based encoder neural network, the set of global context tokens corresponding to regions outside the masked portion of the digital image; and
determining, from the set of global context tokens and based on a generative prompt, one or more tokens including the additional contextual information.

14. The system of claim 10, wherein generating the digital image data comprises generating, utilizing the transformer-based generative decoder neural network, a set of modified tokens corresponding to the masked portion of the digital image based on the feature subset of the modified latent feature vector with noise features corresponding to the masked portion.

15. The system of claim 14, wherein combining the digital image data with the additional subset of patches comprises:
determining an additional set of tokens corresponding to the additional subset of patches of the digital image from the latent feature vector in a latent image space;
determining a latent composite image by combining the set of modified tokens with the additional set of tokens in the latent image space; and
generating the modified digital image utilizing a latent decoder neural network on the latent composite image.

16. The system of claim 10, wherein generating the digital image data comprises:
determining a text prompt indicating an object to generate within the masked portion of the digital image; and
determining, utilizing the transformer-based generative decoder neural network, the modified latent feature vector, based on the feature subset representing the subset of patches of the digital image and the text prompt.

17. A non-transitory computer readable medium storing instructions thereon that, when executed by at least one processor, cause the at least one processor to perform operations comprising:
generating, utilizing an encoder neural network, a latent feature vector of a digital image by encoding global context information of the digital image into the latent feature vector;
determining a modified latent feature vector by trimming the latent feature vector to a feature subset corresponding to a masked portion of the digital image;
generating, utilizing a generative decoder neural network on the modified latent feature vector, digital image data corresponding to the masked portion of the digital image; and
generating a modified digital image including the digital image data corresponding to the masked portion combined with additional portions of the digital image.

18. The non-transitory computer readable medium of claim 17, wherein:
generating the latent feature vector comprises utilizing a transformer-based encoder neural network to extract a plurality of tokens representing patches of the digital image; and
determining the modified latent feature vector comprises trimming the latent feature vector to a set of tokens representing patches corresponding to the masked portion of the digital image.

19. The non-transitory computer readable medium of claim 17, wherein generating the digital image data comprises generating, utilizing a transformer-based decoder neural network, a modified feature set from the feature subset corresponding to the masked portion of the digital image.

20. The non-transitory computer readable medium of claim 19, wherein generating the modified digital image comprises:
mapping the modified feature set into a latent image domain utilizing a linear neural network layer;
generating a latent composite image by combining the modified feature set in the latent image domain with an additional feature set corresponding to a portion of the digital image outside the masked portion; and
generating, utilizing a latent decoder neural network, the modified digital image from the latent composite image.
